(19) United States
(12) Patent Application Publication
(10) Pub. No.: US 2014/0177818 A1
(43) Pub. Date: Jun. 26, 2014

(54) VIRTUAL DESKTOP INTERFACE FOR A SERVICE CALL CENTER

(71) Applicant: Futurewei Technologies Co., Ltd., (US)

(72) Inventors: Yi Chang, Saratoga, CA (US); Xin Tan, Hangzhou (CN)

(21) Appl. No.: 13/722,410

(22) Filed: Dec. 20, 2012

(51) Int. Cl. H04M 3/51

(52) U.S. Cl. CPC H04M 3/5183
USPC 379/265.09

(57) ABSTRACT

A method for operating an agent terminal in a call routing environment in which an agent server routes customer service calls to the agent terminal. The method includes the agent terminal establishing a communication link with the agent server over a network, configuring an agent terminal display to display service metric parameters related to an incoming customer service call to be routed to the agent terminal, wherein the service metric parameters are retrieved via the communication link from a configuration database of the agent server; and monitoring and displaying on the agent terminal display: updated service metric parameters throughout a customer service call routed from the agent server.

### FIELD OF THE TECHNOLOGY

The present application relates to the field of communication technology, and more particularly to configuring and the dynamic display of key service metric parameters related to an incoming customer service call to be routed to an agent terminal.

### BACKGROUND

Call center terminals or agent terminals used by many contact center agents usually require full capabilities equivalent to that of a desktop computer or a laptop computer. As a result, the capital investment is high and the equipment gets outdated after a few system requirement updates. In addition, information routed to the call center terminal regarding the pending customer service call and the calls in the queue are usually quite limited. As a result, there is little control over the pending customer service call or the limited information on the overall call traffic assigned to the contact center agent, which results in low service efficiency.

### SUMMARY

The disclosure addresses the above disadvantages using a method and an agent terminal operating in a call routing environment, in which an agent server routes customer service calls to the agent terminal. In an aspect of the disclosure, the method includes establishing, by the agent terminal, a communication link with the agent server over a network. The method further includes configuring an agent terminal display to display service metric parameters related to an incoming customer service call, which is to be routed to the agent terminal. The service metric parameters are retrieved via the communication link from a configuration database of the agent server. The agent terminal monitors and displays on the agent terminal display updated service metric parameters throughout a customer service call routed from the agent server.

In another aspect of the disclosure, an agent terminal in a call routing environment receives customer service calls routed from an agent server. The agent terminal may include at least a processor coupled to a memory. The memory includes instructions operable to cause the processor to: establish a communication link with the agent server over a network over which the agent server routes customer service calls. The processor is also operable to configure an agent terminal display to display service metric parameters related to an incoming customer service call to be routed to the agent terminal. The service metric parameters are retrieved via the communication link from a configuration database of the agent server. The agent terminal may monitor updated service metric parameters throughout a customer service call routed from the agent server. The agent terminal includes a display, which displays the updated service metric parameters.

In another aspect of the disclosure, an agent server routes customer service calls to an agent terminal in a call routing environment, the agent server may receive via a communication link by the agent server, display configuration parameters associated with service metric parameters to be displayed on a display of the agent terminal. The service metric parameters are related to a customer service call to be routed to the agent terminal. The service metric parameters are retrieved from a configuration database of the agent server. The agent server routes the customer service call to the agent terminal. The agent server may monitor and update service metric parameters throughout the routed customer service call, and communicate the updated service metric parameters via the communication link to the display of the agent terminal.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 illustrates a call routing environment, in which an agent server routes customer service calls to an agent terminal, according to an embodiment of disclosure;

FIG. 2A is a flow chart which illustrates exemplary operations for configuring and dynamically displaying service metric parameters on an agent terminal, according to an embodiment of disclosure;

FIG. 2B is a block diagram, which illustrates an exemplary agent server performing monitoring and updating of service metric parameters to the agent terminal display throughout the customer service call, according to an embodiment of disclosure;

FIG. 2C is an exemplary screen shot of an agent terminal, which displays exemplary updated service metric parameters of a customer service call, according to an embodiment of disclosure;

FIG. 2D is another exemplary screen shot of an agent terminal, which displays exemplary updated service metric parameters of a customer service call, according to an embodiment of disclosure; and

FIG. 3 illustrates an exemplary agent terminal in a call routing environment, which is enabled to configure and dynamically displaying service metric parameters received via a network link.

### DETAILED DESCRIPTION OF THE EMBODIMENTS

The problems described above are overcome by providing a method and an agent terminal operating in a call routing environment, in which an agent server routes customer service calls to the agent terminal. The agent terminal establishes a communication link with the agent server over a network. A display of the agent terminal display is configured to display service metric parameters related to an incoming customer service call to be routed to the agent terminal. The service metric parameters are retrieved via the communication link from a configuration database of the agent server. The agent terminal also monitors and displays, on the agent terminal display, updated service metric parameters throughout a customer service call routed from the agent server.

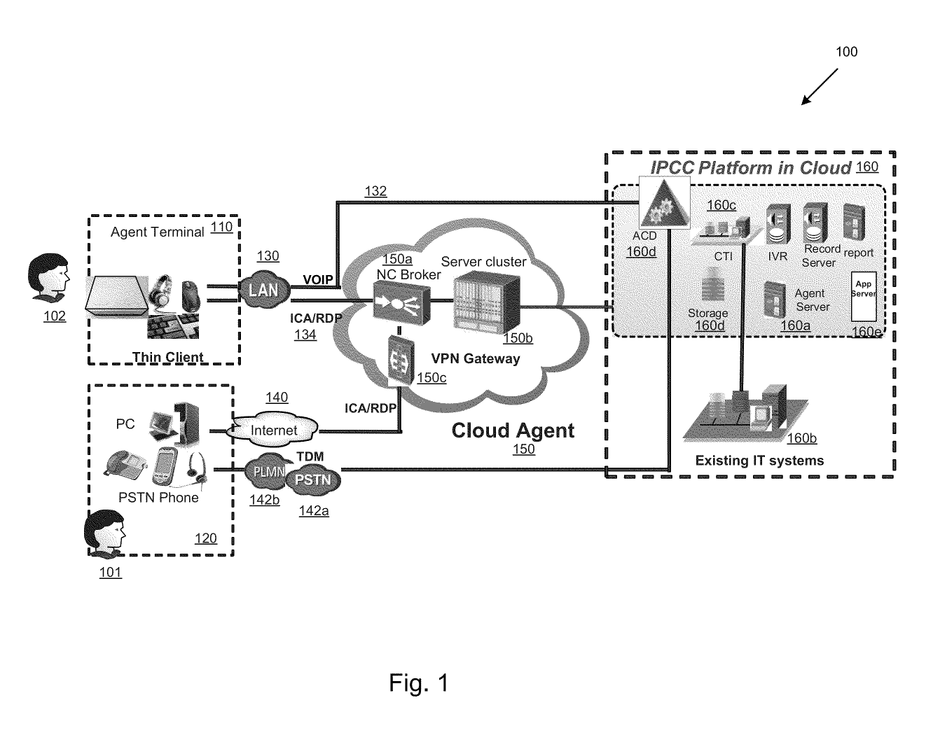

FIG. 1 illustrates a call routing environment (100), in which an agent server (160a) routes customer service calls (120) to an agent terminal (110), according to an embodiment of disclosure. FIG. 1 illustrates that a customer service call (120) may be initiated by a caller (101) through a communication link established through one of: a traditional Public switched telephone network (PSTN) (142a) (i.e., a landline phone), or a mobile phone (120b) via a public land mobile network (PLMN) (142b) (i.e., a mobile handset or a cellular phone). Alternately a customer service call (120) may be initiated over the Internet (140) using one of the virtualization protocols, such as ICA Citrix or Microsoft's remote desktop protocol (RDP), to name a few. The customer calls (120), transmitted via the PSTN, the PLMN or the Internet, may eventually be routed to an inter-process communication (IPCC) cloud platform (160) (which houses an agent server (160a)) through a cloud agent (150) for customer call service.

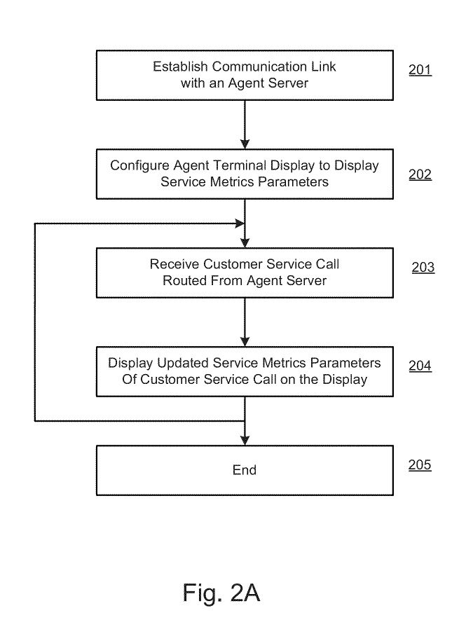

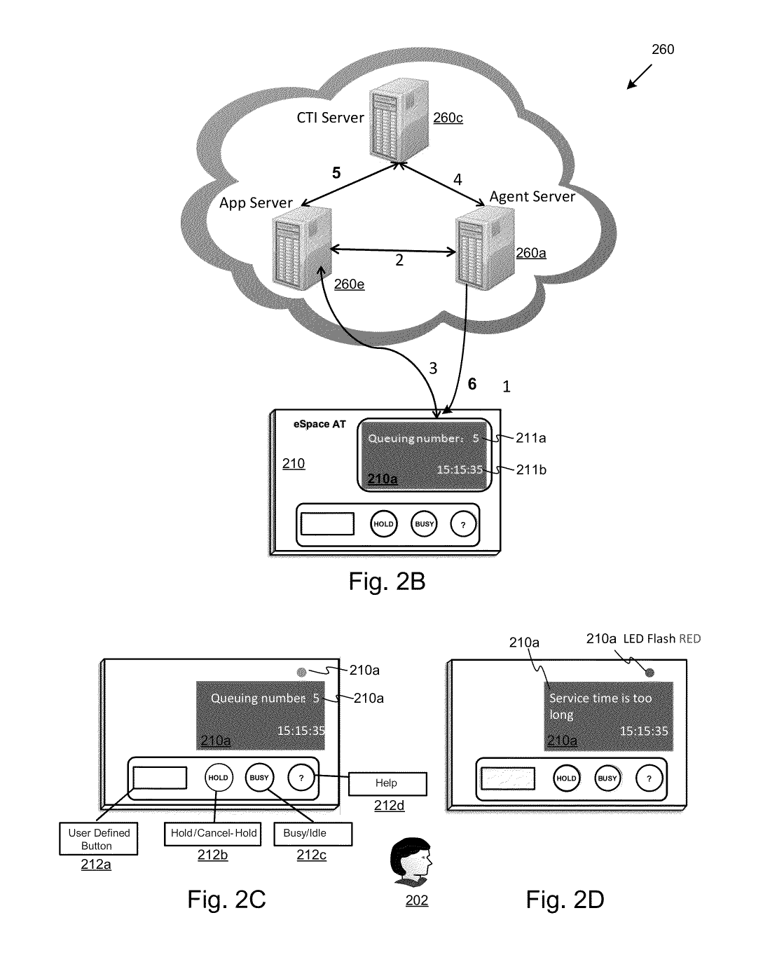

FIG. 1 shows that a contact center agent (102) may receive, via a communication link, a customer service call (120) routed from the agent server (160a) in the IPCC cloud platform (160) using an agent terminal (110). In an embodiment, the agent terminal (110) may be a thin client terminal having a virtual desktop interface. The virtual desktop interface may run one or more application interfaces (APIs), which communicate to the agent server (160a) and/or to an application server (to be discussed in FIG. 2B) in the IPCC cloud platform (160). The application interfaces (API) running on the agent terminal (110) may correspond to a software development kit (SDK), which allows for the creation of an application for a certain software package, such as a software telephone based application to enable the agent terminal (110) to function as a softphone.

The agent terminal (110) may be configured to run on an operating system, such as Windows XP Embedded (XPE) or LINUX, which executes the API (i.e., a software telephone application) and configures the agent terminal (110) as a softphone. Other embedded operating systems may be used as well. In this regard, the agent terminal (110) requires a much simpler hardware platform, one that requires less than the full capabilities required of a desktop or a laptop computer, thus reducing capital overhead required for the service.

The virtual desktop interface of the agent terminal (110) may communicate both text and voice data to the server agent (160a) over a communication link, such as a local area network (LAN) (130). The voice communication may be via Voice over IP (VOIP) (132), and the text communication may be over a virtual private network (VPN) communication. The communication link may be via one of: a WiFi, Ethernet, WiMax or an Internet connection. The voice data communication may also use one of the virtualization protocols, such as Microsoft's RDP, Citrix ICA; VMware's PC-over-IP (PCoIP), to name a few. Throughout the entire routed customer service call (120) from the agent server (160a), the agent terminal (110) may monitor and display the updated service metric parameters.

With the use of a thin client running a specific API, the agent terminal (110), besides having a lower hardware cost, also has other benefits such as lower power consumption, shorter boot up time, lower noise and utilization of less bandwidth (e.g., 150 kbps) to communicate via the internet or via the VOIP path.

The cloud agent (150) may include at least a network center (NC) broker server (150a), a server cluster (150b), and a VPN gateway (150c). The NC broker server (150a) is a network load distributor, which may direct call traffic from the agent terminal (110) to one of the Agent Client call instances (i.e., customer service calls). For example, the NC broker server (150a) may route calls via the Internet communication (e.g., ICA/RDP type communications) to the server cluster (150b). The server cluster (150b) may host many Agent Client call instances in a virtual environment, where the Agent Client instances may be forwarded or connected to the agent server (160a) in the IPCC cloud platform (160).

The IPCC cloud platform (160) includes the agent server (160a), a computer telephony integration (CTI) server (160c), an automatic call distributor (ACD) server (160d) and an application server (160e). The ACD server (160d) receives voice communications over VOIP (132), over the Internet via the cloud agent (150) and over the traditional PSTN/PLMN (142a, 142b). The CTI server (160c) integrates the voice communication and synchronizes the more important service metric parameter with the agent server (160a). The IT system (160b) manages the call traffic and directs the call traffic to the agent server (160a).

The agent server (160a) performs many functions related to all the agent terminals (110). Some of the functions may include: receiving (via a communication link (i.e., VOIP (132) or ICA/RDP (134)) display configuration parameters associated with the service metric parameters related to a customer service call (i.e., an Agent Client instance), which are retrieved from a configuration database (164d) of the agent server. The agent server (160a) also synchronizes with the CTI server (160c) on some of the more important service metrics parameters. In addition, the agent server (160a) may, throughout the routed customer service call, monitor and send updated service metric parameters to the display of the agent terminal (110).

The agent server (160a) may provide the service metric parameters to the application server (160e). The application server (160e) is an application server, which interfaces with at least one API of the agent terminal (110). The application server (160e) may calculate the service metrics parameters of the routed calls and the calls in a queue, and send the calculated results of the service metrics parameters of the routed calls and the calls in the queue for display on the agent terminal display.

FIG. 2A is a flow chart which illustrates exemplary operations for configuring and dynamically displaying service metric parameters on an agent terminal, according to an embodiment of disclosure. FIG. 1 will be referenced to when describing the exemplary operations in FIG. 2A.

Block (201) shows that an agent terminal (110) may establish a communication link (i.e., via LAN (130), VOIP or cloud agent (150), and IPCC cloud platform (160)) with an agent server (160a).

Block (202) shows that the agent terminal (110) may configure the display to display service metrics parameters related to an incoming customer service call to be routed to the agent terminal (110), wherein the service metric parameters are retrieved via the communication link from a configuration database (160d) of the agent server (160a). That is, the agent terminal (110) may retrieve the service metric parameters, or the parameters may be pushed to the agent terminal (110) by the agent server. The service metrics parameters may include but not limited to: a number of calls waiting in a queue, total number of customers and calls served, service time of pending call, average waiting time (AWT), average service time, longest service time, average wrap-up time for pending call, projected call service duration for remaining calls, service category for each of the remaining calls in the queue, total agent idle time, total agent login time, a visual alert to indicate that a predetermined service time threshold for the pending call has been reached and number of calls being put on hold, prompt message to wrap up a call, to name a few.

In addition, configuring of the display may include: selection of service metric parameters to be displayed on the agent terminal (110) display, defining of a display position for the selected service metric parameters on the agent terminal display, and font information associated with the selected service metric parameters. Other parameters for controlling the way in which the information is presented on the display may be communicated as well.

Block (203) shows that the agent terminal (110) may receive a customer service call routed from the agent server (160a). The customer service call may originate from a caller who uses a traditional network, such as the PSTN (142a) or the PLMN (142b) to communicate voice data.

Block (204) shows that the agent server (160a) may monitor and update the service metric parameters throughout the entire customer service call, which is routed to the agent terminal (110). The updated service metric parameters may be displayed on the agent terminal (110) display according to the display configuration set by the contact agent (102) at any time, or after the agent terminal (110) is powered up.

Block 205 shows that the customer service call may be terminated after the contact agent (102) has completed the service. The contact agent (102) may return to block (203) and take a next customer service call in a queue list on the agent terminal display. The agent server (160a) may reset or update the corresponding service metrics parameters for the agent terminal (110).

FIG. 2B is a block diagram, which illustrates an exemplary agent server (260a) performing monitoring and updating of service metric parameters of the agent terminal display (210a) throughout the customer service call, according to an embodiment of disclosure. More specifically, during the customer service call, voice communications (shown as arrow 1) may be communicated (i.e., over VOIP (132) or over the internet via the cloud agent (150)) from the agent terminal (110) to the computer telephony integration (CTI) server (260c). The CTI server (260c) may integrate the voice communications from the automatic call distributor (ACD) server (160d) (see FIG. 1), which receives voice communications from the agent terminal (210) as well as from the customer caller (i.e., over the traditional PSTN/PLMN (142a, 142b) or over the Internet using ICA/RDP). The integrated voice communications may be forwarded to both an agent server (260a) (as arrow 4) and to an application server (260e) (as arrow 5).

The agent server (260a) may work in conjunction with the application server (260e) to monitor and update the service metric parameters throughout the service call routed to the agent terminal (210). The agent server (260a) may provide the service metric parameters (as arrow 2) to the application server (260e). The application server (260e) is an application server, which interfaces with at least one API of the agent terminal (210). The application server (260e) may calculate and update the service metric parameters of the routed calls and the calls in a queue, and send (as indicated by arrow 3) the calculated update results of the service metric parameters of the routed calls and the calls in the queue to be displayed on the agent terminal display. Alternately, the updated service metric parameters may be communicated to the agent server (260a), and sent (as indicated by arrow 6) by the agent server (260a) to the agent terminal display (210a).

FIGS. 2C and 2D are exemplary screen shots of an agent terminal (210), which displays exemplary updated service metric parameters of a customer service call, according to an embodiment. The exemplary screen shots in FIGS. 2C and 2D may depict a graphical user interface (GUI) on a display of the agent terminal (110). Various service metric parameters (e.g., 211a to 211d) and user interface functions (212a to 212d) may be configured and displayed according to a display configuration selected by the contact center agent (202). For example, the display configuration may include a selection of service metric parameters and user interface functions to display, defining a display position for the selected service metric parameters on the agent terminal display (210a), and font information associated with the selected service metric parameters.

The service metric parameters displayed on the agent terminal display (210a) may include but not limited to: a number of calls waiting in a queue (211a), total number of customers and calls served, service time of pending call (211b), average waiting time (AWT), average service time, longest service time, average wrap-up time for pending call, projected call service duration for future or remaining calls, service category for each of the remaining calls in the queue, total agent idle time, total agent login time, a visual alert (211c) to indicate that a predetermined service time threshold for the pending call has been reached and number of calls being put on hold, prompt message to wrap up a call (211d), to name a few.

The service metric parameters displayed on the agent terminal display (210a) may have a default setting value. For example, a default value of displaying five calls waiting in the queue and a default call service duration of 12 minutes may be set as a predetermined service time threshold for each customer service call. When the time has exceeded 12 minutes (at hour 15:15:35), a visual alert of a blinking light emitting diode (LED) in red color may flash, and a prompt message to wrap up a call (211d) may be shown on the agent terminal display (210a).

If the pending caller requires more assistance, the contact agent (202) may push a user interface function key “Hold/Cancel-Hold” (212b) to put the pending call on hold. The contact agent (202) may also push the user interface function key “Help” (212d) to seek for assistance from a supervisor, or wait for a prompt message with instructions to resolve an issue with the client on the pending call. During the pending call, the user interface functions key “Busy/Idle” (212c) may indicate that the agent terminal (210) is in busy mode, such that the agent server (260a) may not queue more than 5 calls to the agent terminal (210).

The agent server (260a) may keep track of each service call category, and monitor the call duration of each service call for the service call category to project call service duration for future calls of or remaining calls of the same service call category. An average waiting time for each service call category may be calculated for statistical data and for training purposes.

Accordingly, the service metric parameters displayed on the agent terminal display (210a) may produce at least the following benefits:
(1) Provide a valuable feedback tool to the contact agent (202) to improve call efficiencies with visual alerts when reaching predetermined service time threshold;
(2) Collect field statistics on the actual calls for each type of service call category to estimate a more accurate projected call duration for future calls of the same service call category;
(3) Provide field statistics to improve or to stream line the service process to resolve client's issues more expediently;
(4) Provide call statistics on contact agent's productivity, effectiveness and customer satisfaction for training purposes and for rewarding based on merits;
(5) Provide dynamic display of updated service metric parameters which indicates the call traffic for the contact agent;
(6) Reconfigurable display features customized for each contact agent.

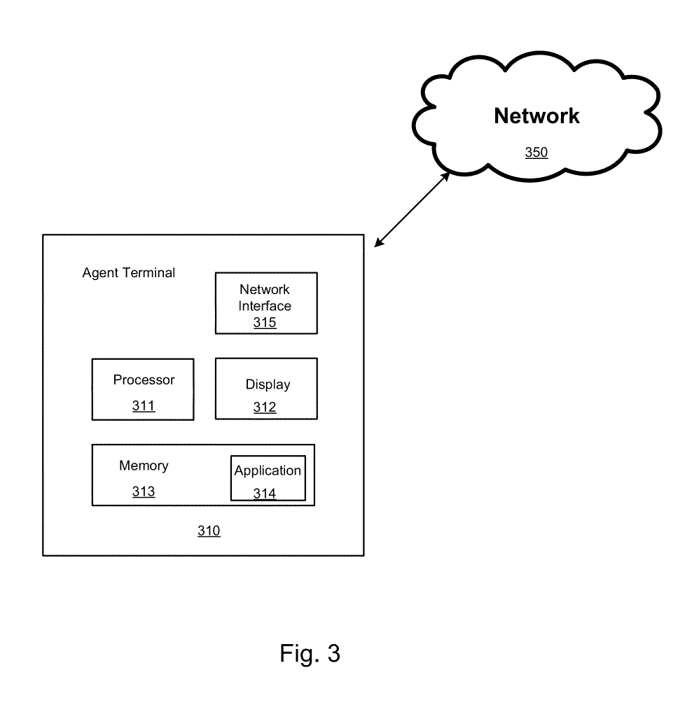

FIG. 3 illustrates an exemplary agent terminal (310) in a call routing environment, which is enabled to configure and dynamically display service metric parameters received via a network link (350). The agent terminal (310) may include at least a processor (311), coupled to a memory (313). The processor may execute code or instructions of an operating system, and at least one API (such as a software telephone application (314)) to enable the agent terminal (310) to function as a softphone. The processor executing the at least one API may monitor and display the updated the service metric parameters on a display (312).

The display (312) may be configured via a GUI to display service metric parameters related to an incoming customer service call to be routed to the agent terminal, wherein the service metric parameters are retrieved via the communication link (350) from a configuration database of the agent server. The agent terminal (310) also includes at least a network interface (315), which enables the agent terminal (310) to communicate to the agent server via the network link (350) utilizing virtual network protocols selected from one of: RDP, Citrix ICA, VMware and PCoIP.

Those of ordinary skill in the art should understand that all or a part of the operations or steps in the method according to the embodiments of the present disclosure may be implemented by a program instructing relevant hardware, and the program may be stored in a non-transitory computer readable storage medium, such as a ROM/RAM, a magnetic disk, or an optical disk, which are executed in a machine, such as an agent terminal, a wireless tablet, an end-user mobile device, in a server, or cloud computing infrastructure.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents.

1. In a call routing environment in which an agent server routes customer service calls to an agent terminal, a method for operating the agent terminal, the method comprising:
establishing by the agent terminal, a communication link with the agent server over a network;
configuring an agent terminal display to display service metric parameters related to an incoming customer service call to be routed to the agent terminal, wherein each service metric parameter displayed by a particular agent terminal is related to that particular agent terminal, and wherein the service metric parameters are retrieved via the communication link from a configuration database of the agent server; and
monitoring and displaying on the agent terminal display: updated service metric parameters throughout a customer service call routed from the agent server.

2. The method according to claim 1, further comprising sending via the communications link, voice data to facilitate servicing of the service call routed from the agent server.

3. The method according to claim 1, wherein the service metrics parameters comprise: a number of calls waiting in a queue, total number of customers served, service time of pending call, longest service time, average waiting time (AWT), average wrap-up time for pending call, projected call service duration for future or remaining calls, service category for each of the remaining calls in the queue, total agent idle time, total agent login time, a visual alert to indicate that a predetermined service time threshold for the pending call has been reached, number of calls being put on hold, and a prompt message to wrap up a call.

4. The method according to claim 1, wherein the configuring comprises:
selecting service metric parameters and user interface functions to display,
defining a display position for the selected service metric parameters on the agent terminal display, and
selecting font information associated with the selected service metric parameters.

5. The method according to claim 1, wherein the service metric parameters are displayed on a thin client terminal having a virtual desktop interface.

6. The method according to claim 1, wherein the network link comprises one of: WiFi, Ethernet, WiMax, or Internet connections.

7. The method according to claim 1, further comprising utilizing one of a plurality of virtual network protocols.

8. An agent terminal in a call routing environment in which an agent server routes customer service calls, the agent terminal comprising:
at least a processor coupled to a memory, the memory including instructions operable to cause the processor to:
establish a communications link with an agent server over a network, wherein the agent server routes customer service calls;
configure an agent terminal display to display service metric parameters related to an incoming customer service call to be routed to the agent terminal, wherein each service metric parameter displayed by a particular agent terminal is related to that particular agent terminal, and wherein the service metric parameters are retrieved via the communications link from a configuration database of the agent server; and
monitor updated service metric parameters throughout a customer service call routed from the agent service; and
a display operable to display the updated service metric parameters.

9. The agent terminal according to claim 8, wherein the processor is operable to send via the communication link, voice data to facilitate servicing of the service call routing from the agent server.

10. The agent terminal according to claim 8, wherein the service metric parameters comprise: a number of calls waiting in a queue, total number of customers served, service time of pending call, longest service time, average waiting time (AWT), average wrap-up time for pending call, projected call service duration for future or remaining calls, service category for each of the remaining calls in the queue, total agent idle time, total agent login time, a visual alert to indicate that a predetermined service time threshold for the pending call has been reached, number of calls being put on hold, and a prompt message to wrap up a call.

11. The agent terminal according to claim 8, wherein the configuring comprises:
selecting service metric parameters and user interface functions to display,
defining a display position for the selected service metric parameters on the agent terminal display, and
selecting font information associated with the selected service metric parameters.

12. The agent terminal according to claim 8, wherein the service metric parameters are displayed on a thin client terminal having a virtual desktop interface.

13. The agent terminal according to claim 8, wherein the network link comprises one of: WiFi, Ethernet, WiMax, or Internet connections.

14. The agent terminal according to claim 8, further comprising utilizing one of a plurality of virtual network protocols.

15. In a call routing environment in which an agent server routes customer service calls to an agent terminal, a method for operating the agent server,. the method comprising:
receiving via a communication link from the agent server, display configuration parameters associated with service metric parameters to be displayed on a display of an agent terminal, wherein the service metric parameters are related to a customer service call to be routed to the agent terminal, wherein each service metric parameter displayed by a particular agent terminal is related to that particular agent terminal, and wherein the service metric parameters are retrieved from a configuration database of the agent server;
routing the customer service call to the agent terminal by the agent server;
monitoring and updating service metric parameters throughout the routed customer service call; and
communicating the updated service metric parameters via the communication link to the display of the agent terminal.

16. The method according to claim 15, wherein the agent server comprises a web server, and wherein the web server is configured to generate browser code executable by a browser to facilitate specification of the display configuration parameters associated with the agent terminal.

17. The method according to claim 15, further comprising servicing the service call routed from the agent server, via facilitating voice data received from the agent terminal via the communication link.

18. The method according to claim 15, wherein the service metric parameters comprise: a number of calls waiting in a queue, total number of customers served, service time of pending call, longest service time, average waiting time (AWT), average wrap-up time for pending call, projected call service duration for future or remaining calls, service category for each of the remaining calls in the queue, total agent idle time, total agent login time, a visual alert to indicate that a predetermined service time threshold for the pending call has been reached, number of calls being put on hold, and a prompt message to wrap up a call.

19. The method according to claim 15, wherein the network link comprises one of: WiFi, Ethernet, WiMax, or Internet connections.

20. The method according to claim 15, further comprising utilizing one of a plurality of virtual network protocols.
